(19) United States
(12) Patent Application Publication
(10) Pub. No.: US 2008/0256200 A1
(43) Pub. Date: Oct. 16, 2008

(54) Computer application text messaging input and output

(75) Inventor: David E. Elliston, Belmont, CA (US)

Correspondence Address: SCHWEGMAN, LUNDBERG & WOESSNER/SAP, P.O. BOX 2938, MINNEAPOLIS, MN, 55402, US

(73) Assignee: SAP AG

(21) Appl. No.: 11/786,926

(22) Filed: Apr. 13, 2007

(51) Int. Cl. G06F 15/16

(52) U.S. Cl. 709/206

(57) ABSTRACT

The subject matter herein relates to computer application input and output and, more particularly, computer application text messaging input and output. Various embodiments provide systems, methods, and software to enable interaction with computer applications utilizing virtually any text-client, such as an instant messaging or text messaging client application or device. Some embodiments provide the ability for text-client interaction with voice applications, such as interactive voice response applications typically available to telephone callers.

### TECHNICAL FIELD

The subject mater herein relates to computer application input and output and, more particularly, computer application text messaging input and output.

### BACKGROUND INFORMATION

Today, computer applications can be delivered to users in many different ways on many different device types. However, delivery of a single application on more than one device type can pose compatibility problems that may require application customization for the particular device. The costs, both financial and time, commonly prevent application delivery on more than one device.

However, users are beginning to demand access to many applications at all times. Further, today's competitive marketplace is forcing organizations to increase employee productivity. The present subject matter provides solutions that address the cost and time issues and also provide additional channels for delivery of computer applications that provide increased productivity potential by broadening users application accessibility.

### BRIEF DESCRIPTION OF THE DRAWINGS

FIG. 1 is a block diagram of an example system.

FIG. 2 is a block diagram of an example system.

FIG. 3A is a diagram of an example user interface.

FIG. 3B is a diagram of an example user interface.

FIG. 4A is a diagram of an example user interface.

FIG. 4B is a diagram of an example user interface.

FIG. 5 is a diagram of an example user interface.

FIG. 6 is a diagram of an example text-client user interface.

FIG. 7 is a block flow diagram of a method according to an example embodiment.

### DETAILED DESCRIPTION

Enterprise software accessibility has evolved. The days when workers were confined to their desktop to perform business functions are over. With the advent of wireless networks, laptops, and voice technology, employees can access corporate software and data wherever they are. External users can access services with phones even when Internet access is unavailable. However, these channels of access are not perfect.

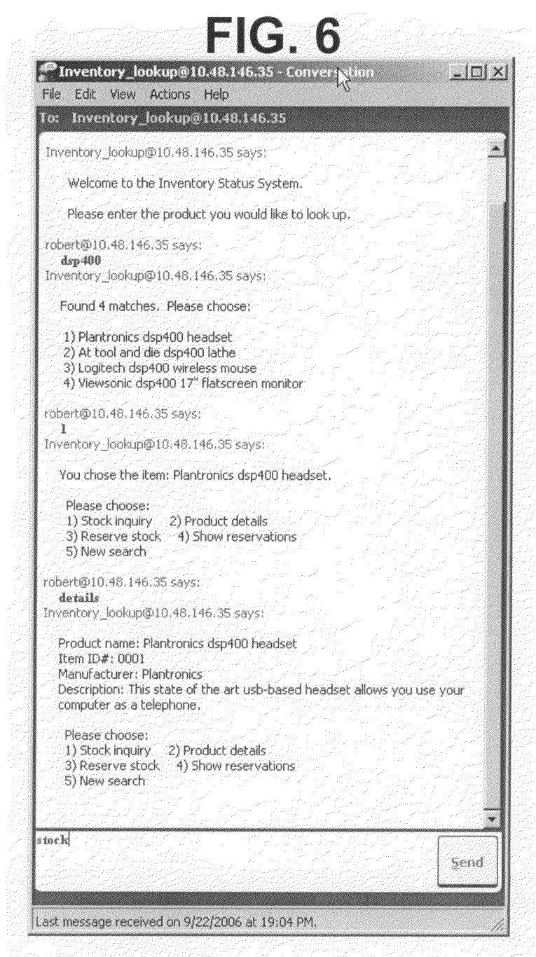

The subject matter herein describes an addition of a new channel of access to applications: Instant Messaging (IM). Instant Messaging (IM), a form of real-time communication between users using text messages, was made popular by IM networks such as the Microsoft Network (MSN), AOL Instant Messenger (AIM), and Yahoo! Messenger. IM has also been rapidly adopted in the workplace through IM clients such as Windows Messenger. With the addition of Instant Messaging as a channel of access, users gain benefits including accessibility, mobility, flexibility, and performance and a new environment within which to create interesting applications. Users are able to perform business functions by having simple IM conversations with applications such as is illustrated in FIG. 6.

Some embodiments provide a simple way to enable IM access to applications by adding a new component, a text gateway, to an existing voice application implementation. In some such embodiments, the text gateway is enabled to interact with an application server or other backend portion of an interactive voice response system as if it were a voice gateway. The text gateway may then translate voice data to and from text enabled data.

Some embodiments also provide an application development environment that enables organizations to rapidly create and deploy custom applications such as Employee Self-Service (ESS) applications that are accessible to the user over the telephone as an interactive voice response system and as a text-enabled application available through an instant messaging application or, in some embodiments, through the SMS functionality of a mobile phone. Users can perform tasks such as payroll inquiries, scheduling, expense reporting, approvals, benefits enrollment, time entry, and many other tasks with a simple telephone call or through instant messaging.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

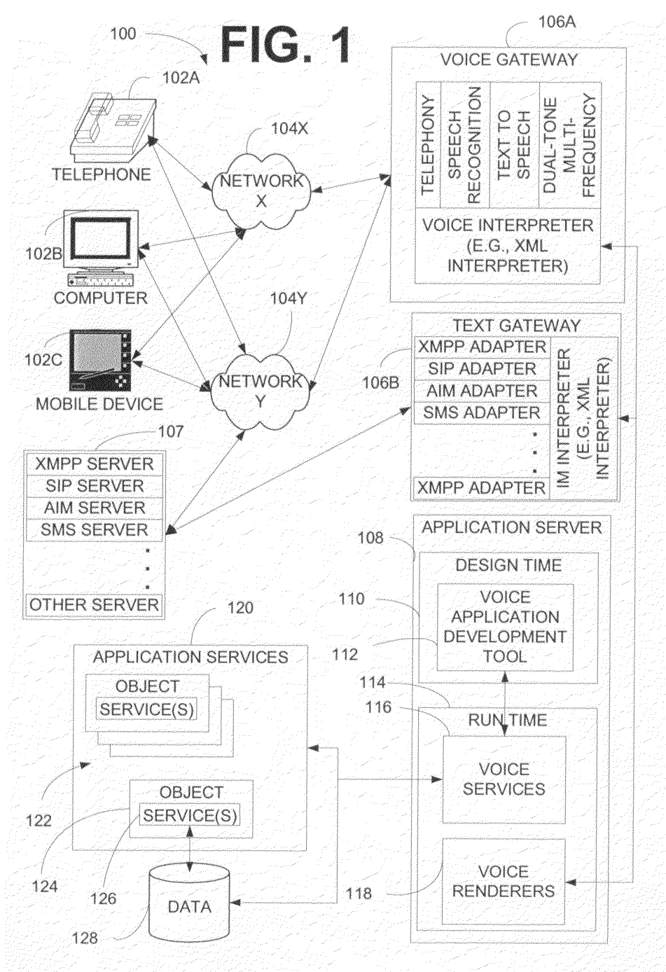

FIG. 1 is a block diagram of an example system 100 embodiment. In this embodiment, the system 100 includes a telephone 102A connected to a network 104X. Also connected to the network 104X is a voice gateway 106A. The voice gateway 106A is operatively coupled to a computing environment that includes an application server 108, application services 120, and data sources 128.

The system 100 may also include a text gateway 106B. The text gateway 106B is also operatively coupled to the computing environment including the application server 108, application services 120, and data sources 128. The text gateway 106B communicates with one or more text servers 107, over a local network (not shown), depending on the type of text communication required for a certain text conversation. The one or more text servers 107 communicate with text clients over network 104Y. The text clients may operate on one or more devices, such as telephone 102A, computer 102B, mobile device 102C, or other device capable of executing an instruction set and communicating over the network 104Y.

In some embodiments, text-client users of applications available on the application server 108 can add the applications to a contacts list. When a user subsequently views his contact list, the listing will show whether or not the application is available for use. The availability is indicated through the use of presence information available on the one or more text servers 107. The text servers 107 typically include a list of users available on the server 107. In some such embodiments, when an adapter of the text gateway 106B is made available, the adapter serves presence information of applications on the application server 108 to the text servers 107 with which the adapter can communicate.

The telephone 102A, in some embodiments, includes virtually any telephone such as a wired or wireless telephone. There may be one or more telephones 102A. The network 104X includes one or more networks capable of carrying telephone signals between a telephone 102A and the voice gateway 106A. Such networks may include one or more of a public switched telephone network (PSTN), a voice over Internet Protocol (VOIP) network, a local phone network, and other wired and wireless network types. Some other wired network types may include networks utilizing one or more wireless network standards such as GSM, TDMA, CDMA, FDMA, PDMA, 1xRTT, 1xEV-DO, Edge, and other technologies.

The voice gateway 106A typically includes a VoiceXML execution environment within which a step in an interactive voice dialogue may execute to receive input and provide output over one or more of the networks 104X and 104Y while connected to a telephone 102A or other device capable of providing telephone functionality, such as a computer operating as a VOIP device. An example voice gateway 106A is available from Nuance of Burlingame, Calif.

In some embodiments, the voice gateway 106A includes various components. Some such components include a telephone component to allow an application executing within the environment to connect to a telephone call over the network 104X, and a speech recognition component to recognize voice input, a text to speech engine to generate spoken output as a function of text. The components may further include a dual-tone multi-frequency (DTMF) engine to receive touch-tone input and a voice interpreter to interpret programmatic data and provide data to the text to speech engine to generate spoken output and to provide grammars to the speech recognition component to recognize voice input.

The voice interpreter, in some embodiments, is an eXtensible Markup Language (XML) interpreter. In such embodiments, the voice interpreter includes, or has access to, one or more XML files that define voice prompts and acceptable grammars and DTMF inputs that may be received at various points in an interactive dialogue.

In some embodiments, the text gateway 106B includes various components. Some such components include an instant messaging interpreter. The instant messaging interpreter, in some embodiments, interprets messages between XML and a generic text format. The text gateway 106B also includes one or more adapters to adapt text between the generic text format to an instant messaging protocol specific format. The adapters also handle message dispatch and receipt. These adapters may include one or more adapters for protocols such as Extensible Messaging and Presence Protocol (“XMPP”), Session Initiation Protocol (“SIP”), America Online instant messaging protocol (“AIM”), Short Message Service (“SMS”) protocol, and other protocols, or derivatives thereof.

The application server 108 is an environment within which applications and application component can execute. The application server 108, in some embodiments, is a J2EE compliant application server 108 includes a design time environment 110 and a runtime environment 114.

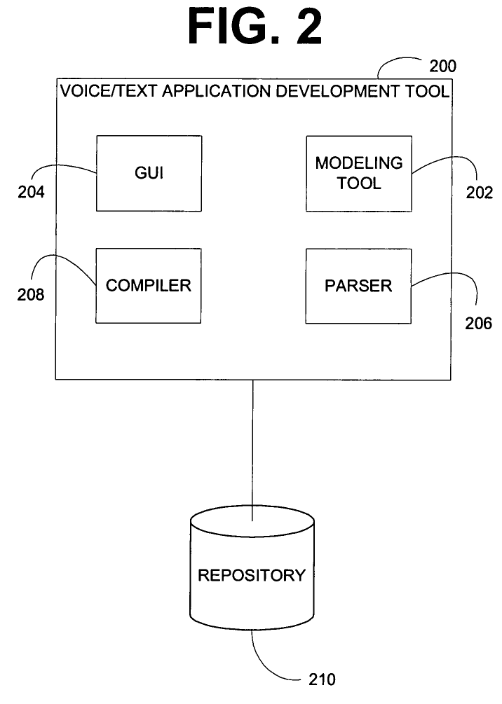

The design time environment includes a voice application development tool 112 that can be used to develop voice applications, such as an Interactive Voice Response (IVR) application that executes at least in part within the voice gateway 106A or text gateway 106B. Voice applications developed utilizing the voice application development tool 112 are also operable to provide application interaction capabilities to text clients. In some embodiments, the voice application development tool 112 provides the ability to developers to specify voice specific text or functionality and text messaging specific text and functionality. The voice application development tool 112 further allows for graphical modeling of various portions of voice and text applications including grammars derived from data stored in one or more data sources 128. In some embodiments, the one or more data sources 128 include databases, objects 122 and 124, object 124 services 126, files, and other data stores. The voice application development tool 112 is described further with regard to FIG. 2 below.

The run time environment 114 includes voice services 116 and voice renderers 118. The voice services and voice renderers, in some embodiments, are configurable to work in conjunction with the voice interpreter of the voice gateway 106A to provide XML documents to service interactive voice response executing programs. In some embodiments, the voice services access data from the application services 120 and from the data sources 128 to generate the XML documents.

The result of the system 100 is the ability to define an application once and deliver the application as an interactive voice response application and as an interactive text response application.

FIG. 2 is a block diagram of an example system embodiment. The system includes a voice application development tool 200. The voice application development tool 200 of FIG. 2 is an example embodiment of the voice application development tool 112.

The voice application development tool 200 includes a modeling tool 202, a graphical user interface (GUI) 204, a parser 206, and a compiler 208. Some embodiments of the system of FIG. 2 also include a repository 210 within which models generated using the modeling tool 202 via the GUI 204 are stored.

The voice application development tool 200 enables voice applications to be modeled graphically and operated within various application execution environments, such as one or more of voice gateways and text gateways, by translating modeled voice applications into different target metadata representations compatible with the corresponding target execution environments. The GUI 204 provides an interface that allows a user to add and configure various graphical representations of functions within a voice application. The GUI 204 may also provide one or more interfaces to add or define application delivery medium specific functionality, text, or other data. For example, a user interface may provide a certain phrase that will be given to a voice caller while interacting with an application while a text messaging user may receive a shorter version of the phrase that is better adapted for text interaction with the application. The modeling tool 202 allows a user to design a graphical model of an application by dragging and dropping icons into a graphical model of a voice application. The icons may then be connected to model flows between the graphical representations of the voice functions. In some embodiments, when a graphical model of a voice application is saved, the graphical model is processed by the parser 206 to generate a metadata representation that describes the voice application. In some embodiments the voice application metadata representation is stored in the repository 120. The metadata representation may later be opened and modified using the modeling tool 202 and displayed in the GUI 204.

In some embodiments, the metadata representation of a voice application created using the GUI 204 and the modeling tool 202 is stored as an XML document, such as the Visual Composer Language (“VCL”) which is an SAP proprietary format. In some such embodiments, this metadata representation of the application, is stored in a format that can be processed by the parser 206 and compiler 208 to generate a further metadata representation of the call and flow logic in a form required or otherwise acceptable to a voice renderer 118 or other application execution environment, such as VoiceObjects, available from VoiceObjects of San Mateo, Calif. In typical embodiments, the voice renderer 118 reads the metadata representation of the call and flow logic, and generates a series of descriptions of single steps in the call in a format, such as VoiceXML, which is suitable for interpretation by a standard Voice Gateway.

As discussed above, the modeling tool 202 and the GUI 204 include various graphical representations of functions within a voice application that may be added and configured within a graphical model. The various graphical representations of functions within a voice application may include a graphical listen element. A graphical listen element is an element which allows modeling of a portion of a voice application that receives input from a voice application user, such as a caller. A graphical listen element includes a grammar that specifies what the user can say and will be recognized by the voice application. The listen element, in voice embodiments, listens for a user to speak. The listen element, in text messaging embodiments, waits for a user to text a message into the system which may then be processed as if a user spoke into the system.

Thus, through use of the modeling tool 202 and the GUI 204, an application can be modeled and an encoded representation can be generated that can be utilized by one or both of a voice gateway and text gateway without manually coding a voice application and/or a text application. This reduces complexity and errors in coding voice applications and text applications and reduces the time necessary to create, modify, and update voice and text applications. Further, by providing the ability to define an application once, but deliver the application via voice and text channels, the benefits of application development are increased.

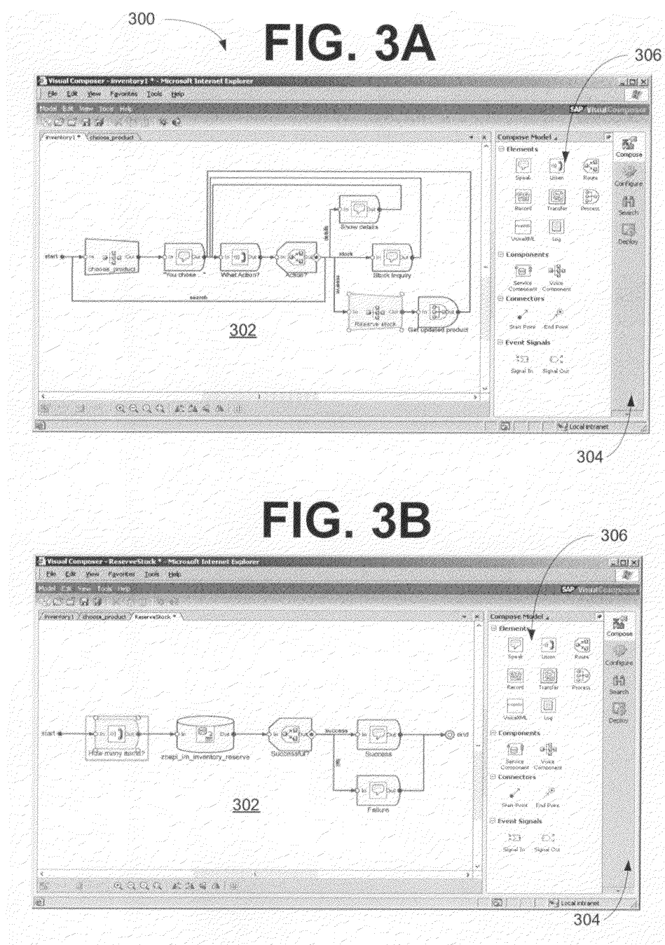

FIG. 3A is a diagram of an example user interface 300 embodiment. The user interface 300 includes a design portion 302, a menu portion 304, and an element portion 306. The design portion 302 is a workspace within which a user may drag elements from the element portion 306 and drop to create voice application flows. The menu portion 304 allows a user to select various user interfaces to create, test, organize, configure and perform other development tasks related to voice and text application development.

The flow illustrated within the design portion 302 workspace is an example voice/text application flow. The example flow is in the context of a voice/text application that operates to serve as an inventory application The flow includes a start point, a “choose_product” voice element that prompts the user for input and listens for that input, and a speak element that provides confirmation of the input. The flow also includes a listen element that may prompt the user for an action to take and listens for input. The flow may then branch to an action such as the speak element to that provides details of selected product, to a speak element providing information in response to a stock inquiry, or to a reserve stock voice element, which may include an additional flow for the specific element. The flows may return to a previous portion of the flow or may include further elements such as the process element to get updated products.

FIG. 3B is a diagram of another example user interface embodiment. The user interface of FIG. 3B provides a view of the additional flow of the reserve stock voice element. Thus, a particular flow, such as the flow illustrated in FIG. 3A, may include additional sub-flows, such as the flow illustrated in FIG. 3B. The combination of flows defines a particular application.

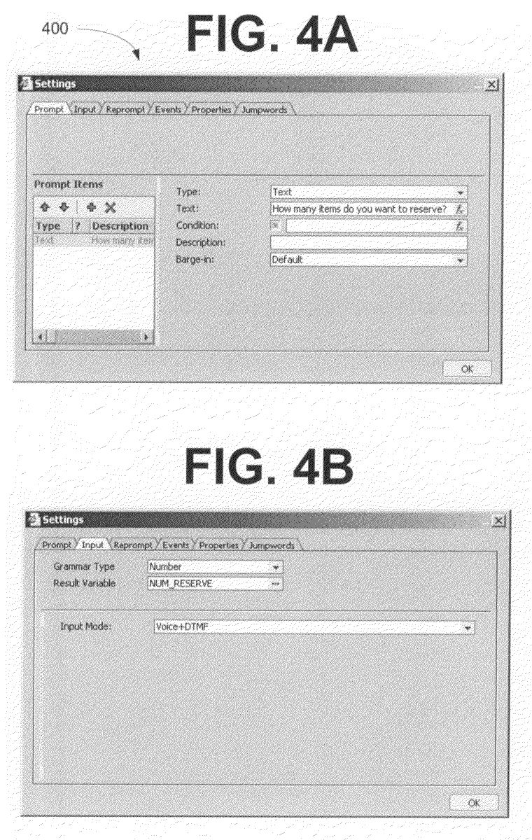

When a user wishes to configure an element to modify element properties, the user selects the element to configure in the design portion 302 and selects the configure item of the menu portion 304. In this instance, the user selects the “How Many Items” listen element and selects the configure item. As a result, the user interface 400 of FIG. 4A is displayed.

FIG. 4A is a diagram of an example user interface 400 embodiment. The user interface 400 includes tabs which may be selected to configure various portions of the selected element. The “Prompt” tab is displayed in the example user interface 400 and allows the user to configure the properties of a prompt of the element. The user may selected another tab, such as the “Input” tab illustrated in FIG. 4B. Here the user may configure what the acceptable inputs are and in which mode the input may be received. The other illustrated tabs allow the user to configure other portions of the selected element. The tabs and settings available to configure typically vary from element type to element type. In some embodiments, the available settings for a particular element type may even vary, depending on the specific embodiment.

In some example embodiments, the user may also specify certain aspects of certain elements, such as a specific listen element aspect. The specified type of listen element may be a “graphical” listen element. A graphical listen element allows a user to tie the listen element to one or more data sources from which to build a grammar that the voice/text application under development will listen for.

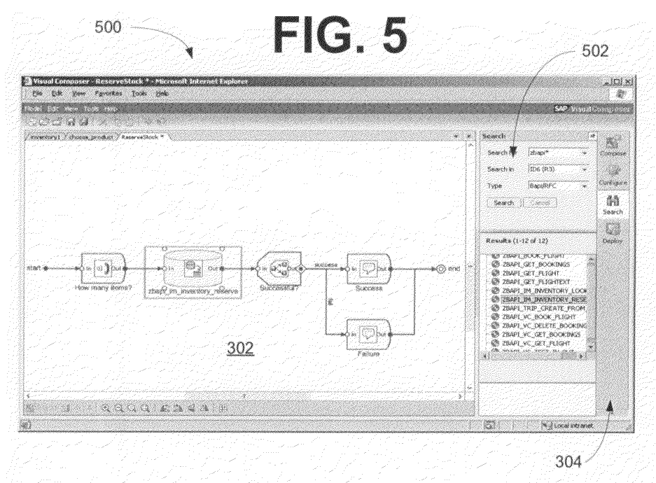

FIG. 5 is a diagram of an example user interface 500 embodiment. The user interface 500 includes the design portion 302, the menu portion 304, and a search portion 502 that allows a user to search for data. The search portion, in some embodiments, allows a user to search for data, such as data available from an object service, a backend process, a database, or other data store or source. The results of a search are displayed within the search portion 502 of the user interface 502 and can be added and removed from the design portion 302 via drag-and-drop functionality. The user interface 500 illustrates selection of the “zbapi_im_inventory_reserve” service item previously illustrated in FIG. 3B. The search portion in this embodiment may be used to associate the “zbapi_im_inventory_reserve” service item to one or more specific data items.

FIG. 6 is a diagram of an example text-client user interface. The text-client user interface provides an example of a text interaction with a voice application. A text-client user views a presence listing of contacts in a contact list, including the illustrated “Inventory Status System.” The user may then select the “Inventory Status System.” The welcome message is provided to the user and requests the product the user is looking for. The user then provides the requested input and a listing is provided with further instructions on what input is expected. The user enters “1” to specify the product and the application requests further input. The user may then reply with the number of the addition information desired, or the text label. The acceptable inputs are defined in the voice application behind the text presentation as a grammar. Thus, a user may be able to provide other inputs to achieve the desired result depending on the specific grammar of the application. Although the text-client user interface is illustrated within a computer-based instant messaging tool, the text-client user interface may be provided in many other forms. For example, the text-client interface may be an SMS utility of a mobile telephone or other SMS or text messaging enabled device. In other embodiments, the text-client interface is a XMPP/Jabber enabled instant messaging client, such as WebMessenger available for Blackberry devices available from Research In Motion of Waterloo, Ontario, Canada.

Some embodiments including the text gateway 106B of FIG. 1 can be integrated with event handlers. An event handler is a process that includes event definitions and event specific processes to execute upon the occurrence of a defined event. Events may include virtually anything, such as a device or system error, an actual or impending service level objective/agreement violation, receipt of a type of request, such as a customer credit request, or any other type of system issue or data occurrence within a system.

In some embodiments, an event specific process may include logic to initiate an instant message session with one or more users. In such embodiments, the text gateway may include a group session module. A group session module may perform several functions. These functions may include functionality to identify if one or more people needed for an instant message session are available by querying user presence information on one or more text servers 107, as shown in FIG. 1. These functions may also include functionality to initiate an instant message session with each of the users identified as present. After a session is initiated, the group session module receives all instant messages and repeats these messages to all of the users on the session other than the sender.

In some embodiments including the group session module, users may want to request information from the system. For example, if the event triggering the instant messaging session is a system error, a user may need to know other system information to determine what actions to take. In some such embodiments, a user may send a message to the system to request additional information by using a prefix, such as “sys-” and then a command specifying the additional information desired. In some embodiments, a help command is available to help a user identify what additional information may be available. Such a command may be made by send a message such as, “sys-help”. What the system would return, in some embodiments, is determined by the defined grammar of the application. In some embodiments, the additional information available includes one or more commands that can be used to perform various functions, such as functions to correct system errors.

As a result of embodiments including a group session module, an event handler can be coupled with an application defined as a voice application or a text application defined within a voice environment to bring people together in a collaborative chat session.

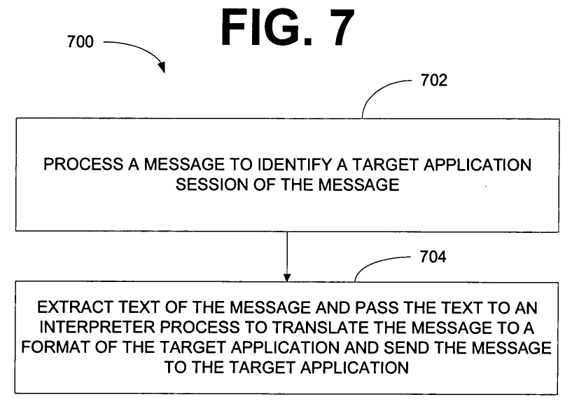

FIG. 7 is a block flow diagram of a method 700 according to an example embodiment. The method 700 is a method of processing a text message received from a client. In some embodiments, the method 700 includes processing a message to identify a target application session of the message 702 and extracting text of the message and passing the text to an interpreter process to translate the message to a format of the target application and send the message to the target application 704.

An application server on which an application executes, may include multiple session of the same application. In such instances, when a message is received, the message needs to be related to one of the application session or a new application session needs to be instantiated. In some embodiments, the proper application session is identified by data in the message itself, such as a session identifier. Other embodiments include determining if a sender address and a recipient address of the message match an existing application session and starting a new application session if there is no match.

In further embodiments, the method 700 may also include receiving, by the interpreter process, a response to the message from the target application and extracting a text portion from the response and forwarding the text to the client.

It is emphasized that the Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

What is claimed is:

1. A method of processing a text message received from a client, the method comprising:
processing a message to identify a target application session of the message;
extracting text of the message and passing the text to an interpreter process to translate the message to a format of the target application and send the message to the target application.

2. The method of claim 1, further comprising:
receiving, by the interpreter process, a response to the message from the target application;
extracting a text portion from the response and forwarding the text to the client.

3. The method of claim 1, wherein the message is an instant messaging message.

4. The method of claim 1, wherein the target application is an interactive voice response application.

5. The method of claim 1, wherein the messages exchanged by the interpreter processes and target application are encoded in a voice-application derivative of extensible markup language.

6. The method of claim 1, wherein processing the message to identify a target application session of the message includes:
determining if a sender address and a recipient address of the message match an existing application session; and
starting a new application session if there is no match.

7. A system comprising:
an application server including one or more voice-enabled applications operable on the application server to provide data and services of an interactive voice response system to callers through a voice gateway; and
a text gateway enabled to communicate with the one or more voice-enabled applications of the application server and one or more text-based client types to allow the text-based clients to access the one or more voice-enabled applications in a text message format.

8. The system of claim 7, wherein the text gateway and the voice-enabled application of the application server communicate with messages encoded in an extensible markup language format.

9. The system of claim 8, wherein the extensible markup language format is VoiceXML.

10. The system of claim 7, wherein the text gateway includes:
an interpreter to interpret messages between an adapter format and a voice-enabled application format; and
a text-messaging protocol adapter to adapt messages exchanged between the interpreter and the text-messaging protocol adapter for exchange of messages over a text messaging network encoded according to a specific text messaging protocol.

11. The system of claim 10, wherein the text gateway includes two or more text-messaging protocol adapters, each text-messaging protocol adapter configured to communicate according to a specific text-messaging protocol.

12. The system of claim 10, wherein the text messaging protocol is Extensible Messaging and Presence Protocol (“XMPP”).

13. The system of claim 10, wherein the text messaging protocol is Session Initiation Protocol (“SIP”).

14. The system of claim 7, wherein the text gateway communicates presence data of the one or more voice-enabled applications of the application server to subscribing text-based clients.

15. The system of claim 7, wherein the text gateway receives presence data of one or more text-based clients.

16. A computer-readable medium, with encoded instruction to cause one or more suitably configured computers to process a text message received from a client by:
processing a message to identify a target application session of the message;
extracting text of the message and passing the text to an interpreter process to translate the message to a format of the target application and send the message to the target application.

17. The computer-readable medium of claim 16, with further instructions to cause the one or more suitably configured computer to process the text message by:
receiving, by the interpreter process, a response to the message from the target application;
extracting a text portion from the response and forwarding the text to the client.

18. The computer-readable medium of claim 16, wherein the message is an instant messaging message.

19. The computer-readable medium of claim 16, wherein the target application is an interactive voice response application.

20. The computer-readable medium of claim 16, wherein processing the message to identify a target application session of the message includes:
determining if a sender address and a recipient address of the message match an existing application session; and
starting a new application session if there is no match.
